(19) United States
(12) Patent Application Publication
(10) Pub. No.: US 2025/0335812 A1
(43) Pub. Date: Oct. 30, 2025

(54) EFFICIENT EXTENSION TO RECOGNIZE NEW LANGUAGES

(71) Applicants: Lemon Inc., Grand Cayman (KY); Beijing Zitiao Network Technology Co., Ltd., Beijing (CN)

(72) Inventors: Yerbolat Khassanov, Singapore (SG); Zhipeng Chen, Beijing (CN); Tianfeng Chen, Singapore (SG); Tze Yuang Chong, Singapore (SG); Wei Li, Beijing (CN); Jun Zhang, Beijing (CN); Lu Lu, Los Angeles, CA (US); Yuxuan Wang, Los Angeles, CA (US)

(21) Appl. No.: 18/646,579

(22) Filed: Apr. 25, 2024

(51) Int. Cl. G06N 20/00; G10L 15/00; G10L 15/16

(52) U.S. Cl. CPC G06N 20/00; G10L 15/005; G10L 15/16

(57) ABSTRACT

The present disclosure describes techniques for efficiently extending to recognize new languages. A first data flow pipeline of a machine learning model can be maintained. The first data flow pipeline comprises pre-trained parameters and is pre-trained to recognize existing languages based on input audio. A second data flow pipeline of the machine learning model is configured. The second data flow pipeline is configured to utilize the pre-trained parameters of the first data flow pipeline and leverage additional trainable parameters. The machine learning model is fine-tuned by exclusively updating the additional trainable parameters of the second data flow pipeline using data from the new languages. The machine learning model is fine-tuned to recognize the new languages based on input audio while preserving performance in recognizing the existing languages.

### BACKGROUND

Machine learning models are increasingly being used across a variety of industries to perform a variety of different tasks. Such tasks may include audio-related tasks. Improved techniques for utilizing machine learning models for audio-related tasks are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for efficiently extending a machine learning model to recognize new languages in accordance with the present disclosure.

FIG. 2 shows an example system for efficiently extending a machine learning model to recognize new languages in accordance with the present disclosure.

FIG. 3 shows an example system for efficiently extending a machine learning model to recognize new languages in accordance with the present disclosure.

FIG. 4 shows an example process for efficiently extending a machine learning model to recognize new languages in accordance with the present disclosure.

FIG. 5 shows an example process for efficiently extending a machine learning model to recognize new languages in accordance with the present disclosure.

FIG. 6 shows an example process for configuring a second data flow pipeline in accordance with the present disclosure.

FIG. 7 shows an example process for efficiently extending a machine learning model to recognize new languages in accordance with the present disclosure.

FIG. 8 shows an example process for efficiently extending a machine learning model to recognize new languages in accordance with the present disclosure.

FIG. 9 shows an example process for efficiently extending a machine learning model to recognize new languages in accordance with the present disclosure.

FIG. 10 shows an example graph illustrating evaluation results in accordance with the present disclosure.

FIG. 11 shows an example table illustrating evaluation results in accordance with the present disclosure.

FIG. 12 shows an example table illustrating evaluation results in accordance with the present disclosure.

FIG. 13 shows an example table illustrating evaluation results in accordance with the present disclosure.

FIG. 14 shows an example table illustrating evaluation results in accordance with the present disclosure.

FIG. 15 shows an example computing device which may be used to perform any of the techniques disclosed herein.

### DETAILED DESCRIPTION OF ILLUSTRATIVE EMBODIMENTS

Recently, large-scale multilingual automatic speech recognition (mASR) models have gained prominence in the speech community. Typically, these mASR models are pre-trained on extensive amounts of unsupervised data. After pre-training, the mASR models are fine-tuned using supervised and/or weakly-supervised data from publicly available and/or proprietary sources. These mASR models often demonstrate robustness to diverse audio conditions and exhibit broad generalization across domains, tasks, and languages, leading to high popularity among both academia and industry practitioners.

However, it is difficult to extend existing large mASR models to new languages, as doing so demands significant computational resources, involving multiple iterations of re-training with adjusted hyperparameters and potentially modifying the model architecture. Further, access to training data for existing languages may be restricted or entirely absent. As such, extending existing large mASR models to new languages while preserving comparable performance on existing languages presents a substantial challenge. This challenge is further heightened under a language-agnostic scenario, where the language of the input utterance is unknown—an often encountered situation in real-world applications.

Existing techniques that attempt to extend large mASR models to new languages are inefficient and/or ineffective. For example, parameter-efficient fine-tuning techniques, such as adapters, can be ineffective as they can cause the existing large mASR model to forget existing languages. Traditional language integration techniques, like continual learning, are impractical due to the need for training data from existing languages. Straightforward solutions, such as maintaining a separate copy of the large mASR model for each group of languages (potentially preceded by a language identification model), not only incur higher computational and storage resource requirements but also forfeit other benefits offered by multilingual models. As such, improved techniques for extending large mASR models to new languages are needed.

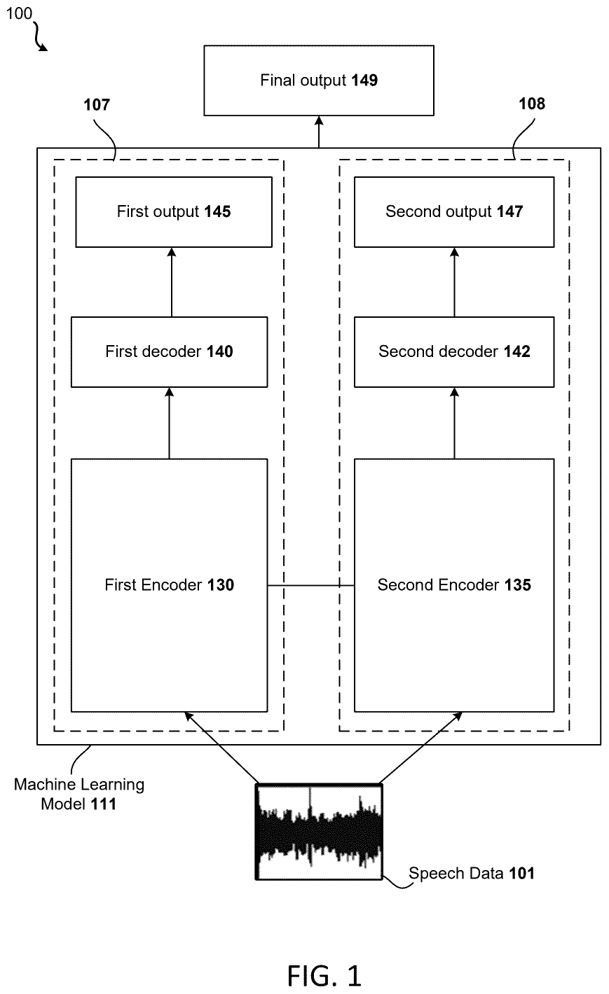

Described herein are improved techniques for extending large mASR models to recognize new languages. FIG. 1 shows an example system 100 for efficiently extending a machine learning model to recognize new languages in accordance with the present disclosure. The system 100 can include a machine learning model 111. The machine learning model 111 can maintain a first data flow pipeline 107. The first data flow pipeline 107 may comprise a large mASR model. The first data flow pipeline 107 may comprise a first encoder 130 and a first decoder 140. The first data flow pipeline 107 comprises pre-trained parameters and is pre-trained to recognize existing languages based on input audio.

The machine learning model 111 may further comprise a second data flow pipeline 108. The second data flow pipeline 108 may comprise a second encoder 135 and a second decoder 142. The second encoder may comprise a low-rank adaptation (LoRA). The second data flow pipeline 108 can be dedicated to new languages. The second data flow pipeline 108 is configured to utilize the pre-trained parameters of the first data flow pipeline 107 and leverage additional language-specific parameters. The additional parameters are trainable. The second data flow pipeline 108 introduces a minimal number of additional parameters and is computationally efficient, thereby enabling to efficiently extend the machine learning model 111 to recognize new languages. Unlike other language extension methods, the second data flow pipeline 108 does not depend on the training data for existing languages.

The machine learning model 111 may receive, as input, speech data 101. The speech data 101 can comprise audio, such as audio of a user speaking or singing. The speech data 101 can be fed into (e.g., input into) both the first data flow pipeline 107 and the second data flow pipeline 108. The first data flow pipeline 107 can be pre-trained to identify existing languages. The speech data 101 fed into the first data flow pipeline 107 can pass through the pre-trained parameters (e.g., pre-trained parameters of the first encoder 130). The pre-trained parameters can be frozen (e.g., kept unchanged) to preserve performance of recognizing existing languages. The first data flow pipeline 107 can recognize existing languages based on speech data 101. For example, the first decoder 140 can generate a first output 145. The first output 145 can recognize first language(s) associated with the speech data 101. The first language(s) can be existing language(s). The first output 145 can indicate transcript(s) in the first language(s).

The second decoder 142 can generate a second output 147. The second output 147 can recognize second language(s) associated with the speech data 101. The second language(s) can be new language(s). The second output 147 can indicate transcript(s) in the second language(s).

In embodiments, the machine learning model 111 may generate final output 149. The final output 149 can be the first output 145 or the second output 147. Determining the final recognition output 149 can include comparing probability scores (e.g., log-probability scores) associated with the first output 145 to probability scores (e.g., log-probability scores) associated with the second output 147. The final output 149 can be the first output 145 if the probability score associated with the first output 145 is higher than the probability score associated with the second output 147. Conversely, the final output 149 can be the second output 147 if the probability score associated with the second output 147 is higher than the probability score associated with the first output 145.

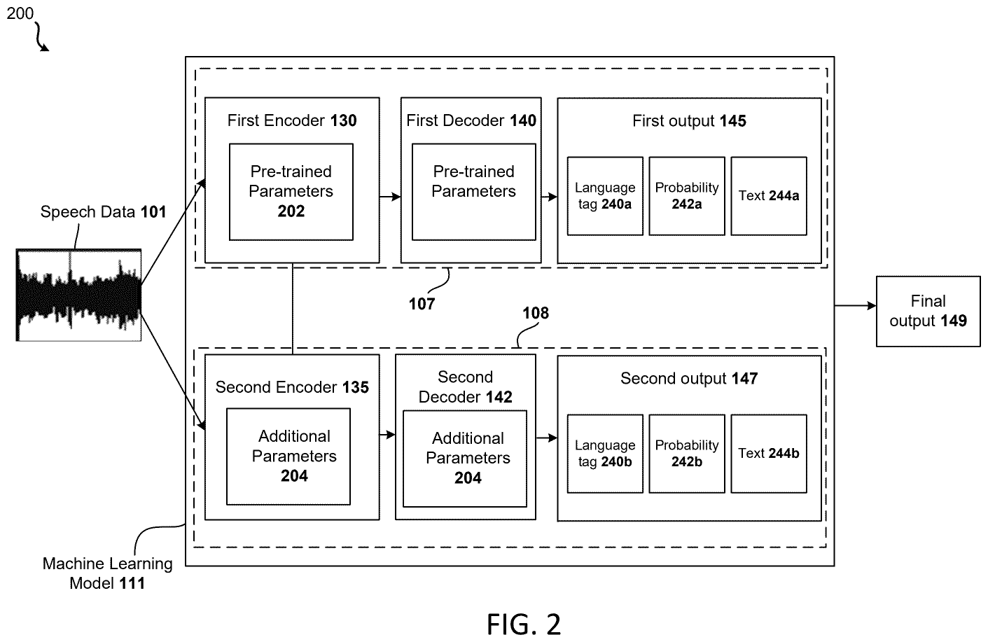

FIG. 2 shows example system 200 for efficiently extending the machine learning model 111 to recognize new languages in accordance with the present disclosure. The system 200 can include the machine learning model 111. As described above, the machine learning model 111 can comprise the first data flow pipeline 107. The first data flow pipeline 107 can include the first encoder 130 and the first decoder 140. The first data flow pipeline 107 can include pre-trained parameters, e.g., pre-trained parameters 202 of the first encoder 130. The first data flow pipeline 107 can be pre-trained to recognize existing languages based on input audio.

The machine learning model 111 can further comprise the second data flow pipeline 108. The second data flow pipeline 108 may be configured to utilize the pre-trained parameters 202 of the first encoder 130. The second data flow pipeline 108 may be configured to leverage additional parameters 204. The additional parameters 204 can be trainable. The machine learning model 111 can be fine-tuned. The machine learning model 111 can be fine-tuned by exclusively updating the additional parameters 204 of the second data flow pipeline 108 using data from new languages. The machine learning model 111 can be fine-tuned to recognize the new languages based on input audio while preserving performance in recognizing the existing languages.

The first encoder 130 of the first data flow pipeline 107 can include sub-layers. The sub-layers can include a multi-head attention (MHA) layer and a feed-forward (FF) layer. The output of the first encoder 130 can be fed into the first decoder 140. The first decoder 140 can generate the first output 145. The first output 145 can identify language tag 240a for the input speech data 101. The language tag 240a can be an identification of an existing language. The first output 145 can indicate a probability score 242a of the identified language tag. The probability score 242a can indicate a probability that the language tag 240a is correct (e.g., accurate). The probability score 242a can be, for example, a log-probability score. The first output 145 can indicate text 244a. The text 244a can include a transcript (e.g., full transcript) of the speech data 101 in the language corresponding to the language tag 240a.

The second data flow pipeline 108 can include the second encoder 135 and the second decoder 142. The second encoder 135 can comprise a low-rank LoRA. The second encoder 135 can include trainable low-rank matrices to efficiently adapt model parameters. The second encoder 135 can utilize the pre-trained parameters 202 of the first encoder 130. The second encoder 135 can be applied to all pre-trained weight matrices in the sub-layers (e.g., the MHA layer and the FF layer) of the first encoder 130. The output of the second encoder 135 can be fed into the second decoder 142.

The second decoder 142 can generate the second output 147. In the decoding stage, the pre-trained weight matrices of the first data flow pipeline 107 may not be merged with the LoRA of the second encoder 135. The second output 147 can identify language tag 240b for the input speech data 101. The language tag 240b can be an identification of a new language. The second output 147 can indicate a corresponding probability score 242b. The probability score 242b can indicate a probability that the language tag 240b is correct (e.g., accurate). The probability score 242b can be, for example, a log-probability score. The second output 147 can indicate text 244b. The text 244b can include a transcript (e.g., full transcript) of the speech data 101 in the language corresponding to the language tag 240b.

In embodiments, a final recognition output 149 is determined. The final recognition output 149 can be the first output 145 or the second output 147. Determining the final recognition output 149 can include comparing the probability scores 242a and 242b. The final recognition output 149 can be the first output 145 if the probability score 242a is higher than the probability score 242b. The final recognition output 149 can be the second output 147 if the probability score 242b is higher than the probability score 242a.

The difference between the probability scores 242a and 242b can be compared to a predetermined threshold. If the difference between the probability scores 242a and 242b does not satisfy (e.g., is less than) the predetermined threshold, average probability scores (e.g., average log-probability scores) of the text 244a and the text 244b can be compared. The final recognition output 149 can be the first output 145 if the average probability score of the text 244a is higher than the average probability score of the text 244b. The final recognition output 149 can be the second output 147 if the average probability score of the text 244b is higher than the average probability score of the text 244a.

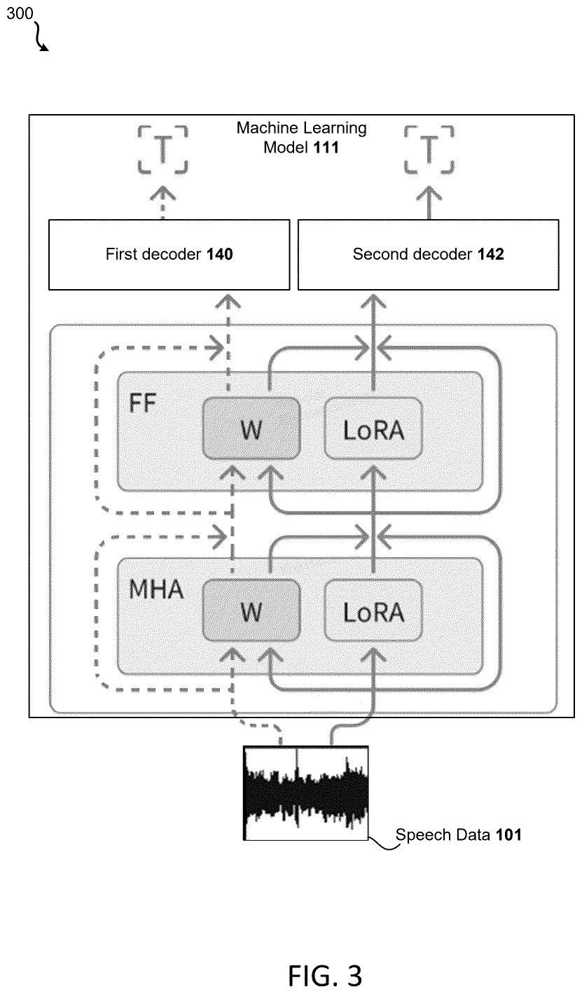

FIG. 3 shows example system 300 for efficiently extending to recognize new languages in accordance with the present disclosure. The system 300 comprises a first data flow pipeline (e.g., the first data flow pipeline 107) represented by the dashed pipeline in FIG. 3. The system 300 further comprises a second data flow pipeline, (e.g., the second data flow pipeline 108) represented by the solid pipeline in FIG. 3.

To expand the machine learning model 111 to incorporate new languages, the second decoder 142 component can facilitate the output token units for new languages. The second decoder 142 can be initialized randomly. The second decoder 142 can be modeled using any network architecture, including but not limited to a Long short-term memory (LSTM) network to enhance decoding speed. The second decoder 142 can be utilized alongside a 2-head additive attention mechanism, forming a Listen, Attend, and Spell (LAS) framework.

Distinct final layer normalization may be applied before passing encoder outputs from the first data flow pipeline and the second data flow pipeline to their respective decoders (i.e., the first decoder 140 and the second decoder 142). The output format of the second decoder 142 can mirror the structure of the output of the first decoder 140 (e.g., a prediction of a unique language tag followed by a transcript).

The second decoder 142 for new languages acts as a language model (LM), conditioned on both the previous context and the output features of the encoder component. As the parameters of the first encoder 130 remain unchanged to preserve performance in existing languages, the first encoder 130 lacks exposure to new languages. Dedicating a distinct pipeline to new languages with its own parameters is akin to having a new encoder. LoRA may be employed to implement computational inefficiencies.

LoRA introduces trainable low-rank matrices A and B to efficiently adapt model parameters to a new domain. Specifically, LoRA can be applied to all pre-trained weight matrices W in the multi-head attention (MHA) and the feed-forward (FF) sub-layers of the encoder of the first data flow pipeline (i.e., the dashed pipeline in FIG. 3). This may result in the following computation: h=Wx+BAx. As a result, the second data flow pipeline (i.e., the solid pipeline in FIG. 3) leverages important feature transformations from the pre-trained matrices, along with the language-specific LoRA module.

While it is possible to allocate a separate LoRA module for each new language, a single LoRA module can be utilized for all new languages. Additionally, separate residual connections can be maintained for the second data flow pipeline. During fine-tuning of the machine learning model 111, the parameters of the second decoder 142 and LoRA can be exclusively updated using data from new languages. In the decoding stage, the LoRA may not be merged with the pre-trained weight matrices.

The challenge inherent in employing multiple decoders (e.g., the first decoder 140 and the second decoder 142) lies in determining the final recognition output without prior knowledge of the input audio language ID. To tackle this issue, a decoder selection strategy may be used. The decoder selection strategy can facilitate a fully language-agnostic mode. First, log probability scores of identified language tags from each decoder for a given input audio can be compared. If the difference falls below a predetermined threshold (t), the average log-probability scores of the full transcripts can be compared. Adjusting this threshold facilitates management of decoding speed. A smaller threshold, for instance, enables decision-making without calculating scores for the remaining tokens using both decoders. Further, a bias score (B) can be added to the average log-probability score of the second decoder 142, enabling the prioritization of one decoder over the other.

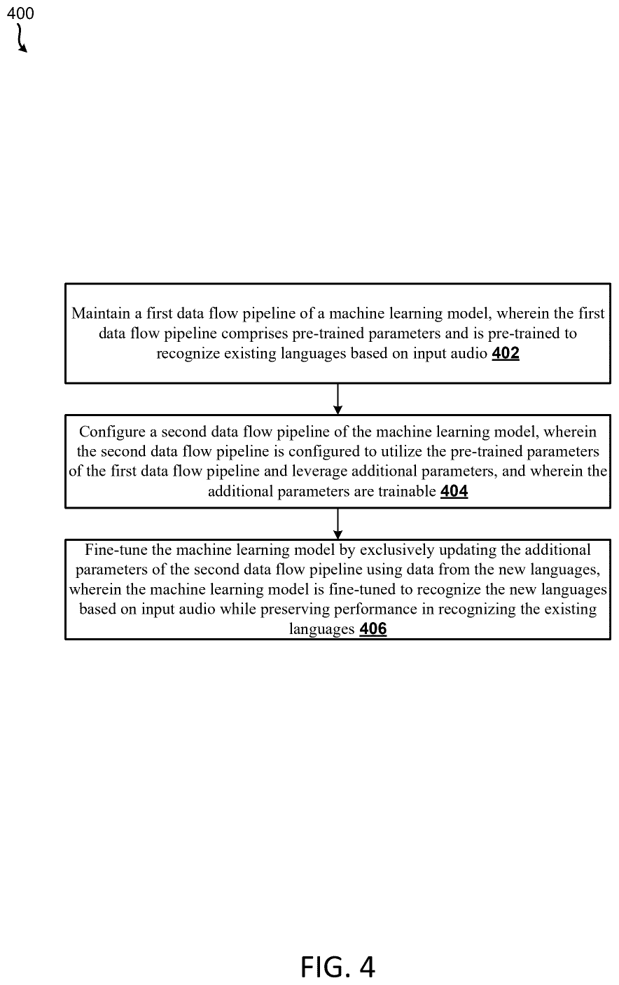

FIG. 4 illustrates an example process 400 for efficiently extending a machine learning model to recognize new languages. Although depicted as a sequence of operations in FIG. 4, those of ordinary skill in the art will appreciate that various embodiments may add, remove, reorder, or modify the depicted operations.

At 402, a first data flow pipeline of the machine learning model can be maintained. The first data flow pipeline (e.g., the first data flow pipeline 107 in FIGS. 1-2, the dashed pipeline in FIG. 3) can comprise pre-trained parameters. The first data flow pipeline is pre-trained to recognize existing languages based on input audio. At 404, a second data flow pipeline (e.g., the second data flow pipeline 108 in FIGS. 1-2, the solid pipeline in FIG. 3) of the machine learning model can be configured. The second data flow pipeline can be configured to utilize the pre-trained parameters of the first data flow pipeline. The second data flow pipeline can leverage additional parameters. The additional parameters can be trainable.

At 406, the machine learning model can be fine-tuned. The machine learning model can be fine-tuned by exclusively updating the additional parameters of the second data flow pipeline using data from the new languages. The machine learning model can be fine-tuned to recognize the new languages based on input audio while preserving performance in recognizing the existing languages.

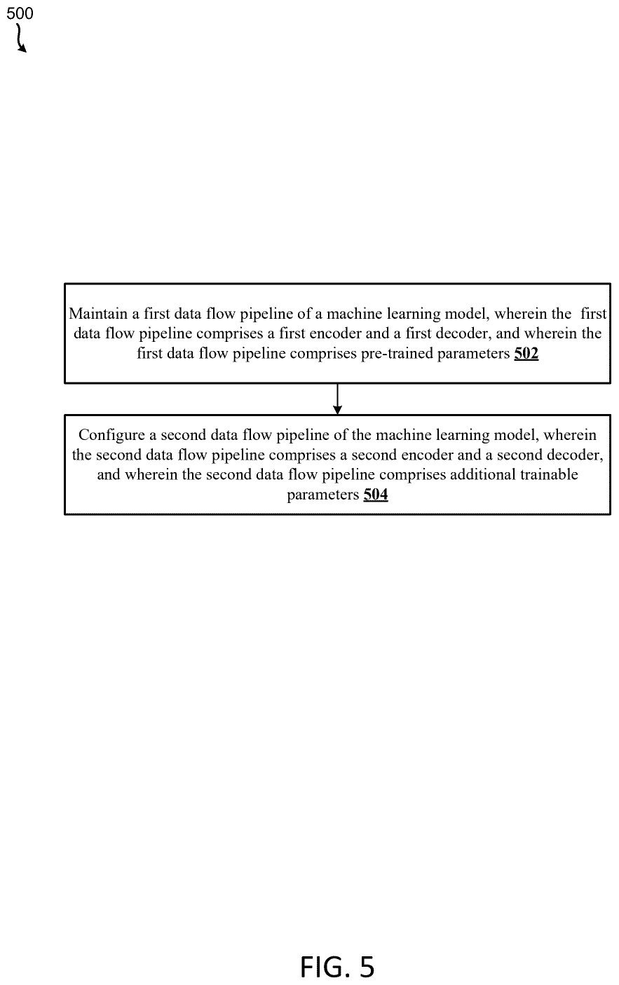

FIG. 5 illustrates an example process 500 for efficiently extending a machine learning model to recognize new languages. Although depicted as a sequence of operations in FIG. 5, those of ordinary skill in the art will appreciate that various embodiments may add, remove, reorder, or modify the depicted operations.

At 502, a first data flow pipeline (e.g., the first data flow pipeline 107 in FIGS. 1-2, the dashed pipeline in FIG. 3) of the machine learning model can be maintained. The first data flow pipeline can comprise pre-trained parameters. The first data flow pipeline is pre-trained to recognize existing languages based on input audio. The first data flow pipeline can comprise a first encoder (e.g., the first encoder 130). The first data flow pipeline can comprise a first decoder (e.g., the first decoder 140). At 504, a second data flow pipeline (e.g., the second data flow pipeline 108 in FIGS. 1-2, the solid pipeline in FIG. 3) of the machine learning model can be configured. The second data flow pipeline can be configured to utilize the pre-trained parameters of the first data flow pipeline. The second data flow pipeline can leverage additional parameters. The additional parameters can be trainable. The second data flow pipeline can comprise a second encoder (e.g., the second encoder 135). The first data flow pipeline can comprise a second decoder (e.g., the second decoder 142).

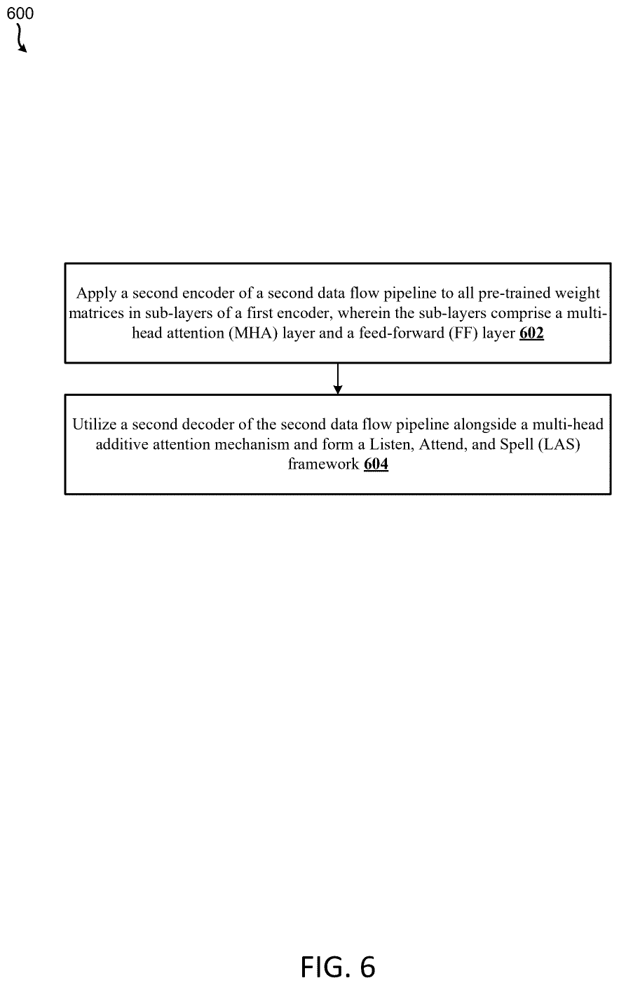

FIG. 6 illustrates an example process 600 for configuring a second data flow pipeline. Although depicted as a sequence of operations in FIG. 6, those of ordinary skill in the art will appreciate that various embodiments may add, remove, reorder, or modify the depicted operations.

A second data flow pipeline (e.g., the second data flow pipeline 108 in FIGS. 1-2, the solid pipeline in FIG. 3) can include a second encoder and a second decoder. At 602, a second encoder (e.g., the second encoder 135) of a second data flow pipeline can be applied to all pre-trained weight matrices in sub-layers of a first encoder (e.g., the first encoder 130). The first encoder may be associated with a first data flow pipeline. The sub-layers of the first encoder can include a multi-head attention (MHA) layer and a feed-forward (FF) layer. At 604, the second decoder (e.g., the second decoder 142) can be utilized alongside a multi-head additive attention mechanism. Utilizing the second decoder alongside the multi-head additive attention mechanism can cause formation of a Listen, Attend, and Spell (LAS) framework.

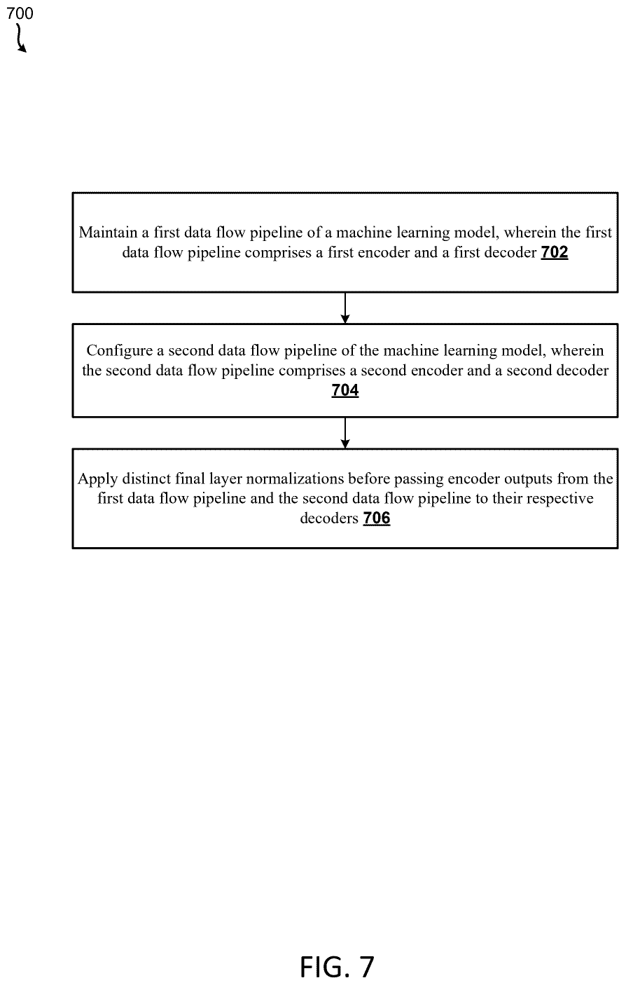

FIG. 7 illustrates an example process 700 for efficiently extending a machine learning model to recognize new languages. Although depicted as a sequence of operations in FIG. 7, those of ordinary skill in the art will appreciate that various embodiments may add, remove, reorder, or modify the depicted operations.

At 702, a first data flow pipeline of the machine learning model can be maintained. The first data flow pipeline (e.g., the first data flow pipeline 107 in FIGS. 1-2, the dashed pipeline in FIG. 3) can comprise pre-trained parameters. The first data flow pipeline is pre-trained to recognize existing languages based on input audio. The first data flow pipeline can comprise a first encoder. The first data flow pipeline can comprise a first decoder. At 704, a second data flow pipeline of the machine learning model can be configured. The second data flow pipeline (e.g., the second data flow pipeline 108 in FIGS. 1-2, the solid pipeline in FIG. 3) can be configured to utilize the pre-trained parameters of the first data flow pipeline. The second data flow pipeline can leverage additional parameters. The additional parameters can be trainable. The second data flow pipeline can comprise a second encoder. The first data flow pipeline can comprise a second decoder.

At 708, distinct final layer normalizations can be applied. The distinct final layer normalizations can be applied before passing encoder outputs from the first data flow pipeline and the second data flow pipeline to their respective decoders. The output format of the second decoder can mirror the structure of the output of the first decoder (e.g., a prediction of a unique language tag followed by a transcript).

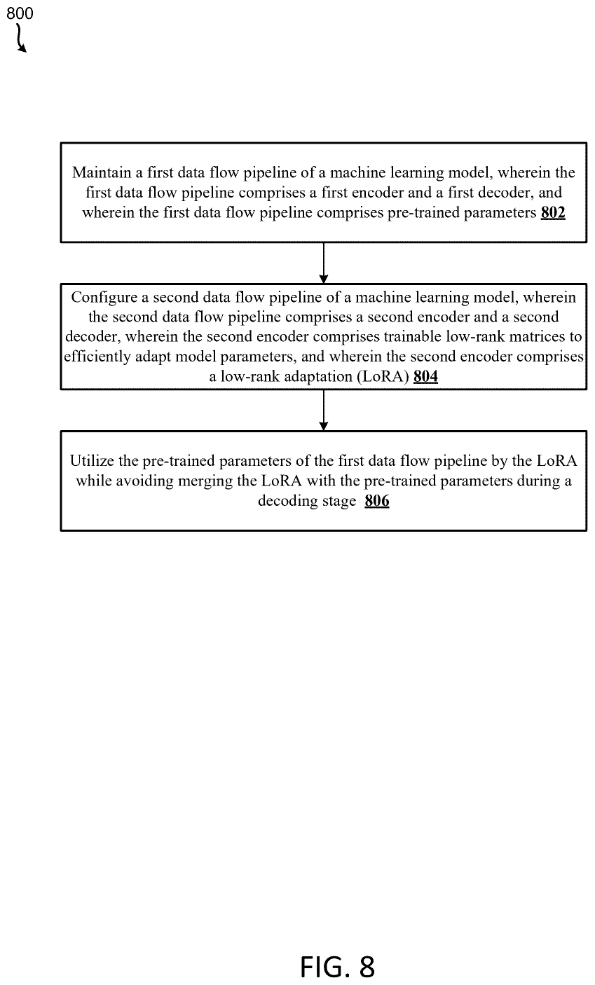

FIG. 8 illustrates an example process 800 for efficiently extending a machine learning model to recognize new languages. Although depicted as a sequence of operations in FIG. 8, those of ordinary skill in the art will appreciate that various embodiments may add, remove, reorder, or modify the depicted operations.

At 802, a first data flow pipeline of the machine learning model can be maintained. The first data flow pipeline (e.g., the first data flow pipeline 107 in FIGS. 1-2, the dashed pipeline in FIG. 3) can comprise pre-trained parameters. The first data flow pipeline is pre-trained to recognize existing languages based on input audio. The first data flow pipeline can comprise a first encoder. The first data flow pipeline can comprise a first decoder.

At 804, a second data flow pipeline of the machine learning model can be configured. The second data flow pipeline (e.g., the second data flow pipeline 108 in FIGS. 1-2, the solid pipeline in FIG. 3) can comprise a second encoder. The second data flow pipeline can comprise a second decoder. The second encoder can comprise trainable low-rank matrices to efficiently adapt model parameters. The second encoder can comprise a LoRA. At 806, the pre-trained parameters of the first data flow pipeline can be utilized by the LoRA while avoiding merging the LoRA with the pre-trained parameters during a decoding stage.

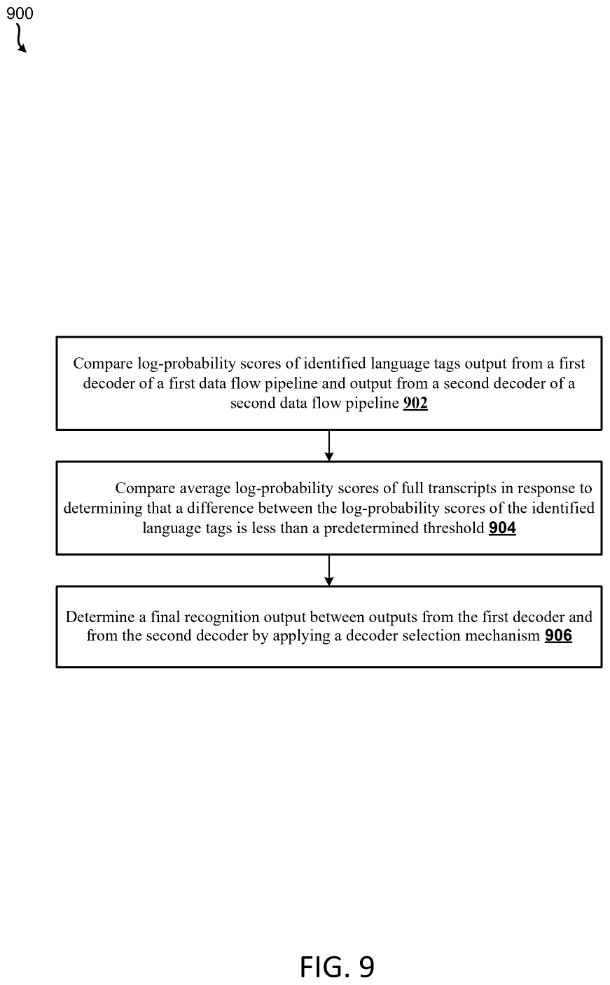

FIG. 9 illustrates an example process 900 for efficiently extending a machine learning model to recognize new languages. Although depicted as a sequence of operations in FIG. 9, those of ordinary skill in the art will appreciate that various embodiments may add, remove, reorder, or modify the depicted operations.

A final recognition output can be determined. The final recognition output can be first output (e.g., the first output 145 from the first data flow pipeline 107) or second output (e.g., the second output from the second data flow pipeline 108). At 902, log-probability scores of identified language tags output from a first decoder of a first data flow pipeline and output from a second decoder of a second data flow pipeline can be compared.

At 904, average log-probability scores of full transcripts can be compared. The average log-probability scores of the full transcripts can be compared in response to determining that a difference between the log-probability scores of the identified language tags is less than a predetermined threshold. Comparing the average log-probability scores of the full transcripts can comprise comparing an average log-probability score of a full transcript from the first data flow pipeline with an average log-probability score of a full transcript from the second data flow pipeline.

At 906, a final recognition output between outputs from the first decoder and from the second decoder can be determined. The final recognition output can be determined by applying a decoder selection mechanism. The decoder selection mechanism can determine that the final recognition output is the first output if the log-probability score of the identified language tags output from the first decoder is higher than the log-probability score of the identified language tags output from the second decoder. Conversely, the decoder selection mechanism can determine that the final recognition output is the second output if the log-probability score of the identified language tags output from the second decoder is higher than the log-probability score of the identified language tags output from the first decoder.

A difference between the log-probability scores of the identified language tags output from the first data flow pipeline and the second data flow pipeline can be compared to a predetermined threshold. If the difference between the log-probability scores falls below the predetermined threshold, average log-probability scores of full transcripts from the first and second data flow pipelines can be compared.

The decoder selection mechanism can determine that the final recognition output is the first output if the average log-probability score of the full transcript from the first data flow pipeline is higher than the average log-probability score of the full transcript associated with the second data flow pipeline. Conversely, the decoder selection mechanism can determine that the final recognition output is the second output if the average log-probability score of the full transcript associated with the second data flow pipeline is higher than the average log-probability score of the full transcript associated with the first data flow pipeline.

The performance of the machine learning model 111 was evaluated. For evaluation, the Whisper (Large-V2) model was used for the first data flow pipeline. The Whisper model is a multitask and multilingual speech processing system with 1.5 billion parameters, employing an encoder-decoder Transformer network. The Whisper model is trained on a diverse dataset of 680,000 hours, encompassing various speech processing tasks like multilingual speech recognition, speech translation, spoken language identification, and voice activity detection. This dataset comprises audio paired with transcripts sourced from the Internet, ensuring a wide distribution across different environments, recording setups, speakers, and languages. Throughout the experiments, the parameters of the Whisper model remained unchanged to preserve its performance in speech recognition for existing languages and other tasks.

Experiments were conducted on 19 languages selected from the FLEURS3 dataset. Each language was represented by approximately 10 hours of training data. Each language had not been encountered by the Whisper model previously. The output vocabulary for these languages was formed from the unified text using a byte-level byte pair encoding (BPE) algorithm, with a size set to 2,000.

For evaluation, the second decoder was implemented using a single-layer LSTM with 512 hidden units. In the case of LoRA, various rank values were explored, and tuning of the corresponding scaling factor a was necessary. It was determined that a values from {1, 2, 4, 8} were preferable. To fine tune the machine learning model 111, data was aggregated from all 19 languages and the second decoder and LoRA components were fine-tuned for 20 k steps using 16 V100 GPUs. For models with over 100M trainable parameters, 4 A100 GPUs was used, maintaining the effective batch size unchanged. The Adam optimizer was employed, and various learning rates from {1×10⁻⁴, 3×10⁻⁴, 5×10⁻⁴, 7×10⁻⁴} were explored. A tri-stage learning rate schedule was implemented, including a warm-up for the initial 10% of steps, a constant rate for the subsequent 40% of steps, and decay during the final 50% of steps. The last checkpoint was selected as the final model.

In all experiments, character error rate (CER) was used as an evaluation metric, and the beam size was set to five. For all test sets, a voice activity detection (VAD) model was applied to segment the utterances into audio chunks not exceeding 30 seconds. This was helpful to avoid long-form decoding heuristics. The Whisper normalization was applied on reference and recognized output text before CER computation. In the input prompt, the <|transcribe|> and <|notimestamps|> special tokens were provided, but these tokens did not include the ground-truth language tag token, assuming the language-agnostic scenario. Additionally, the number of additional parameters introduced by appending the second decoder and LoRA was determined.

The effectiveness of the proposed dual-pipeline with LoRA method in integrating new languages was evaluated. Subsequently, the group-aware scenario was adopted, assuming prior knowledge of the input audio's group (new or existing) and deploying the corresponding decoder. The average CER results for 19 new languages were determined. In the group-aware scenario, the performance of existing languages did not change. The dual-pipeline described herein starts from the input to the initial layer of the encoder network, applying LoRA to all parameters of the encoder, including the MHA and FF sub-layers. The implications of using different rank values for LoRA was explored.

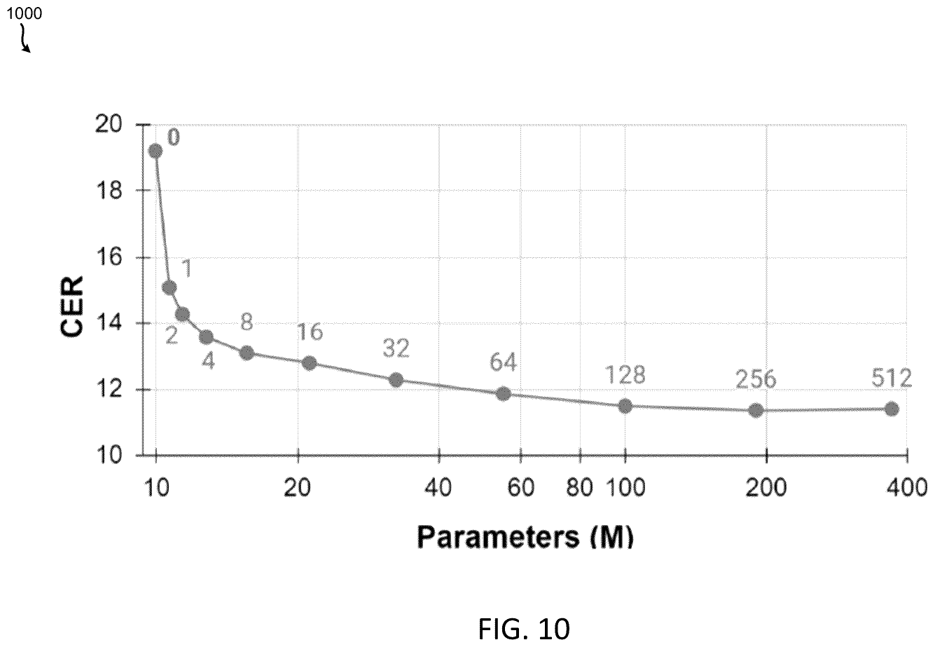

FIG. 10 shows a graph 1000 illustrating the number of additional parameters and average CER results for 19 new languages integrated using the dual-pipeline with LoRA method described herein. Data labels indicate the rank values used in LoRA component. The experimental results in the graph 1000 of FIG. 10 indicate that increasing the rank generally improves CER performance at the cost of increasing the additional parameter size. The best average CER of 11.36% is achieved at rank 256. However, the CER performance converged starting from rank 128. Further, increasing the rank value significantly increases the additional parameter size without bringing any substantial CER improvement. The decoder-only setup, where the LoRA component is omitted by setting the rank value to 0, achieves 19.21% average CER with 9.96M additional parameters. Thus, the dual-pipeline with LoRA method described herein even with the rank of 1 significantly outperforms the decoder-only baseline, achieving 15.09% average CER with 10.7M additional parameters. These results demonstrate the effectiveness of the proposed method.

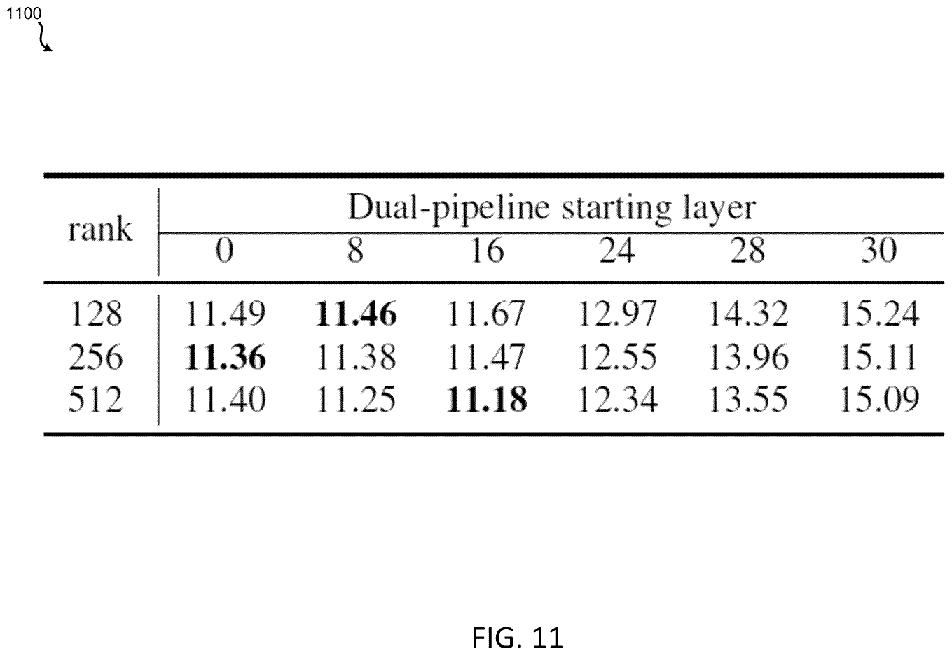

The performance of the dual-pipeline with LoRA method initiated from the intermediate layers of the encoder network was evaluated. This approach is motivated by the observation that the bottom layers of the encoder are more language-invariant and, therefore, can be shared across different languages. Moreover, this strategy reduces the number of additional parameters. Whisper's encoder comprises 32 transformer layers, and the impact of starting the dual-pipeline from layers {8, 16, 24, 28, 30} was investigated. For these experiments, LoRA with ranks set to 128, 256 and 512 were utilized. All experiments were conducted within the context of the group-aware scenario. The experimental results in the table 1100 of FIG. 11 reveal that the dual pipeline initiated from the intermediate layers remains effective. Moreover, initiating it from layers 8-16 does not compromise the CER performance while substantially reducing the number of additional parameters. For instance, with a rank of 512, starting from the 16th layer improved the average CER by approximately 2% relative (from 11.40% to 11.18%) and reduced the number of parameters for LoRA by 50%.

The performance of the dual-pipeline with LoRA method was compared with two strong baseline methods. The group-aware scenario was utilized. All methods were constrained to incorporate fewer than 30 million additional parameters, accounting for less than 0.1% additional parameters per language. The first baseline employs a decoder-only approach. However, in these experiments, a greater number of parameters are allocated to enhance its performance. Various combinations of layers and hidden units were examined, concluding that a four-layer LSTM decoder with 512 hidden units yielded optimal results. The second baseline comprises a supplementary encoder and decoder architecture. In this configuration, alongside a distinct decoder, an extra encoder component is incorporated for new languages. This new encoder component is initialized from the original encoder and attached in a manner that maintains the total encoder depth at the same level, i.e., 32 layers. Due to the parameter constraint, only a single-layer LSTM decoder with 512 units and a single-layer encoder could be added to the output of the 31st layer of the original encoder. The secondary decoder of the dual-pipeline with LoRA method consisted of a single-layer LSTM with 512 units. Additionally, the zero-shot performance was determined, enabled by the use of byte-level BPE tokens as output units in Whisper model.

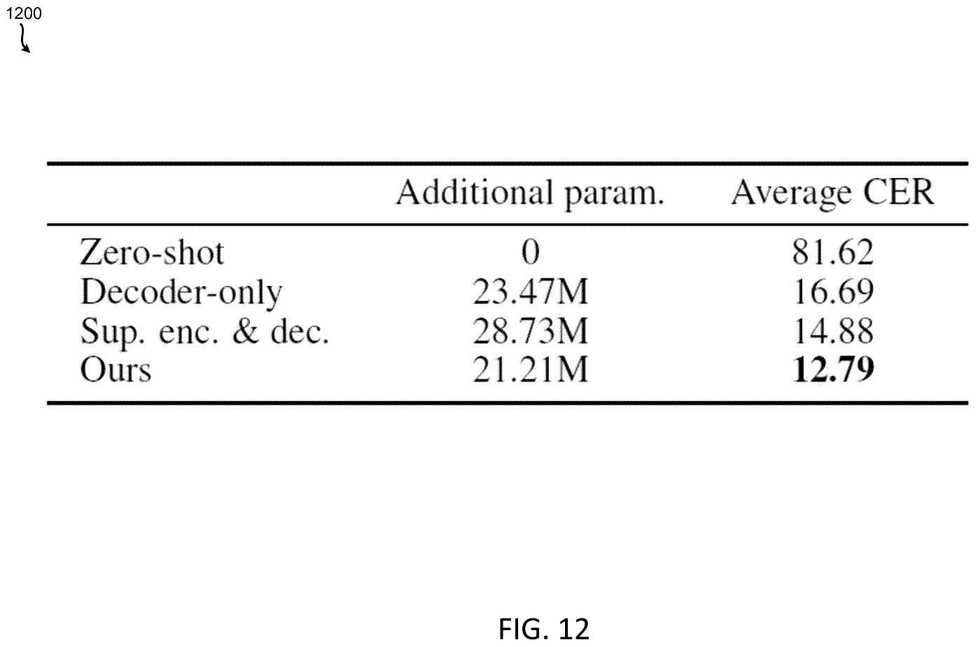

FIG. 12 shows a table 1200 illustrating the number of additional parameters and average CER results for 19 new languages obtained from zero-shot, decoder-only, supplementary encoder and decoder, and the dual-pipeline with LoRA approach described herein. The experiment results in FIG. 12 demonstrate that all baselines exhibit significant improvement over the zero-shot performance, with an average CER improvement of over 80% relative. Among them, the techniques described herein attain the best average CER of 12.79%, marking a 23% and 14% relative improvement over the decoder-only and supplementary encoder-decoder baselines, respectively. Notably, this enhancement is achieved with the least number of additional parameters. The results demonstrate the superiority of techniques described herein over other strong baselines within the constraints of the additional parameter size.

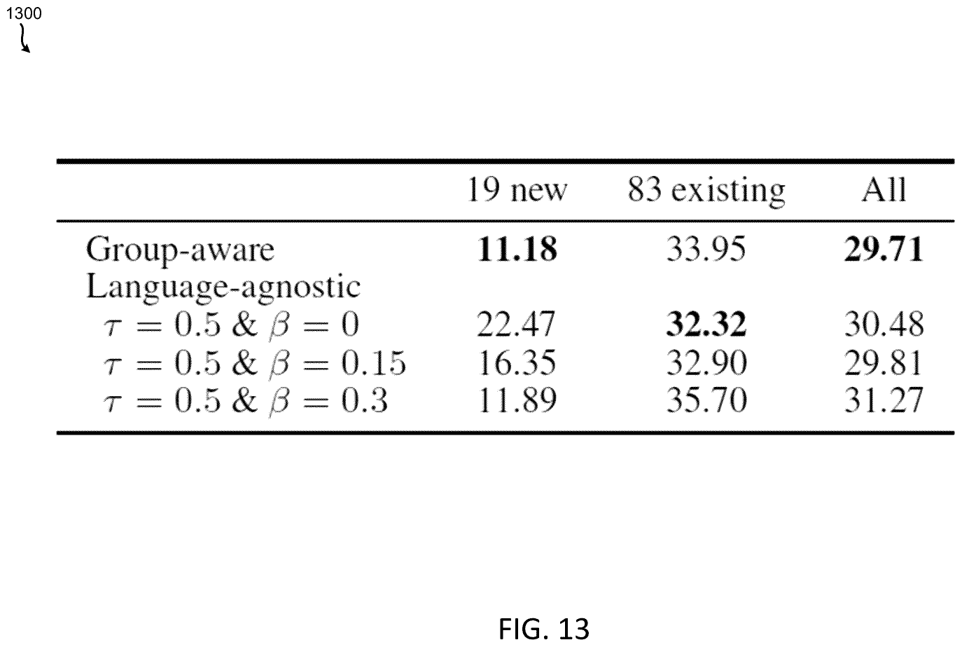

Further, the overall CER results for both existing and new languages under the languages-agnostic scenario were determined. The LoRA rank was set to 512 and the dual-pipeline was initiated from the intermediate layer 16. 102 languages present in the FLEURS dataset, comprising 83 existing and 19 new languages, were evaluated. FIG. 13 shows a table 1300 illustrating average CER results for 19 new and 83 existing languages across the two scenarios: group-aware and language-agnostic, utilizing various thresholds (τ) and bias scores (β) for the decoder selection strategy. As shown in the table 1300, setting τ=0.5 and β=0.15 resulted in the best overall average CER of 29.81%, representing a slight degradation from the group-aware result. Increasing the bias score enhances the performance of the 19 new languages, albeit with a negative impact on the performance of the 83 existing languages.

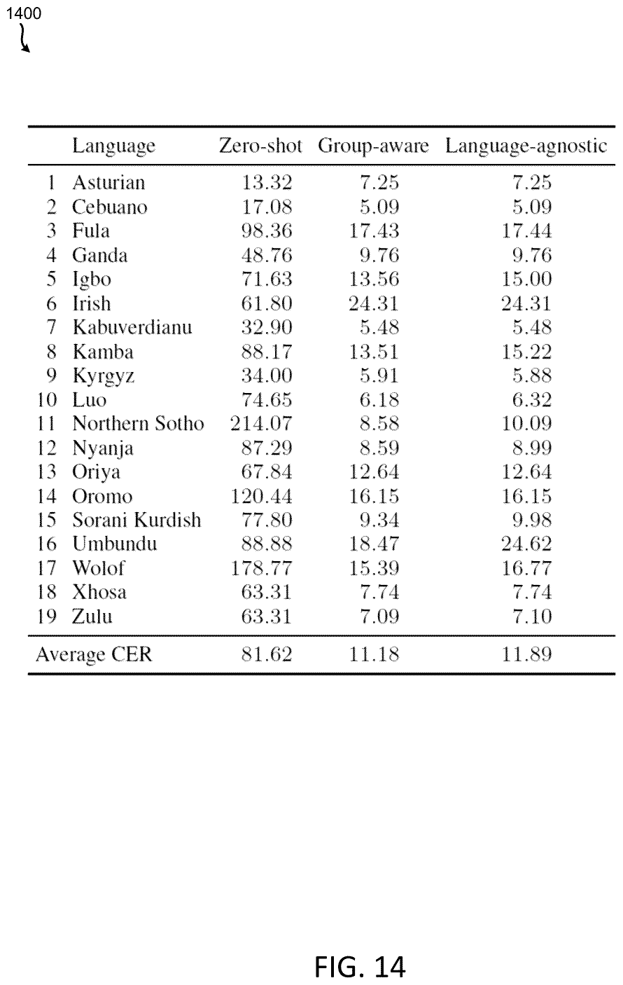

In the language-agnostic mode, the performance on existing languages outperformed the group-aware scenario for β set to 0 and 0.15. This may be attributed to a significant improvement in some low-resource languages, such as Hausa and Somali, where over 50% absolute CER improvements are achieved. Further, per-language CER for the 19 new languages from the FLEURS using zero-shot, group-aware, and language-agnostic operation modes are reported in the table 1400 of FIG. 14. In the language-agnostic scenario, τ=0.5 and β=0.3 were used in decoder selection strategy.

As shown by the evaluation results, the techniques described herein provide an effective method for integrating new languages into a pre-trained mASR system. The techniques described herein utilize the dual-pipeline with LoRA, maintaining two pipelines for existing and new languages. The techniques described herein do not require training data for existing languages and achieves parameter efficiency by leveraging LoRA. Further, the techniques described herein maintain performance on existing languages and tasks by maintaining the parameters of the pre-trained mASR unchanged.

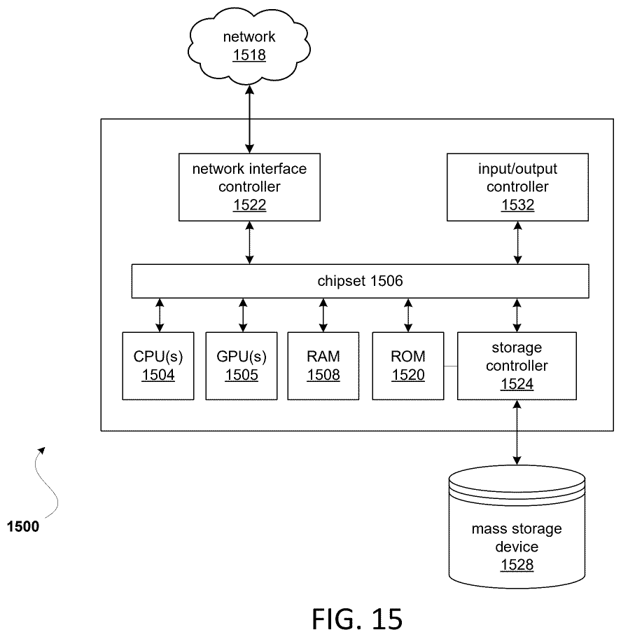

FIG. 15 illustrates a computing device that may be used in various aspects, such as the model(s), components, and/or devices depicted in FIGS. 1-3. With regard to FIGS. 1-3, any or all of the components may each be implemented by one or more instance of a computing device 1500 of FIG. 15. The computer architecture shown in FIG. 15 shows a conventional server computer, workstation, desktop computer, laptop, tablet, network appliance, PDA, c-reader, digital cellular phone, or other computing node, and may be utilized to execute any aspects of the computers described herein, such as to implement the methods described herein.

The computing device 1500 may include a baseboard, or “motherboard,” which is a printed circuit board to which a multitude of components or devices may be connected by way of a system bus or other electrical communication paths. One or more central processing units (CPUs) 1504 may operate in conjunction with a chipset 1506. The CPU(s) 1504 may be standard programmable processors that perform arithmetic and logical operations necessary for the operation of the computing device 1500.

The CPU(s) 1504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1504 may be augmented with or replaced by other processing units, such as GPU(s) 1505. The GPU(s) 1505 may comprise processing units specialized for but not necessarily limited to highly parallel computations, such as graphics and other visualization-related processing.

A chipset 1506 may provide an interface between the CPU(s) 1504 and the remainder of the components and devices on the baseboard. The chipset 1506 may provide an interface to a random-access memory (RAM) 1508 used as the main memory in the computing device 1500. The chipset 1506 may further provide an interface to a computer-readable storage medium, such as a read-only memory (ROM) 1520 or non-volatile RAM (NVRAM) (not shown), for storing basic routines that may help to start up the computing device 1500 and to transfer information between the various components and devices. ROM 1520 or NVRAM may also store other software components necessary for the operation of the computing device 1500 in accordance with the aspects described herein.

The computing device 1500 may operate in a networked environment using logical connections to remote computing nodes and computer systems through local area network (LAN). The chipset 1506 may include functionality for providing network connectivity through a network interface controller (NIC) 1522, such as a gigabit Ethernet adapter. A NIC 1522 may be capable of connecting the computing device 1500 to other computing nodes over a network 1516. It should be appreciated that multiple NICs 1522 may be present in the computing device 1500, connecting the computing device to other types of networks and remote computer systems.

The computing device 1500 may be connected to a mass storage device 1528 that provides non-volatile storage for the computer. The mass storage device 1528 may store system programs, application programs, other program modules, and data, which have been described in greater detail herein. The mass storage device 1528 may be connected to the computing device 1500 through a storage controller 1524 connected to the chipset 1506. The mass storage device 1528 may consist of one or more physical storage units. The mass storage device 1528 may comprise a management component 1510. A storage controller 1524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1500 may store data on the mass storage device 1528 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1528 is characterized as primary or secondary storage and the like.

For example, the computing device 1500 may store information to the mass storage device 1528 by issuing instructions through a storage controller 1524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1500 may further read information from the mass storage device 1528 by detecting the physical states or characteristics of one or more particular locations within the physical storage units.

In addition to the mass storage device 1528 described above, the computing device 1500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1500.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1528 depicted in FIG. 15, may store an operating system utilized to control the operation of the computing device 1500. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1528 may store other system or application programs and data utilized by the computing device 1500.

The mass storage device 1528 or other computer-readable storage media may also be encoded with computer-executable instructions, which, when loaded into the computing device 1500, transforms the computing device from a general-purpose computing system into a special-purpose computer capable of implementing the aspects described herein. These computer-executable instructions transform the computing device 1500 by specifying how the CPU(s) 1504 transition between states, as described above. The computing device 1500 may have access to computer-readable storage media storing computer-executable instructions, which, when executed by the computing device 1500, may perform the methods described herein.

A computing device, such as the computing device 1500 depicted in FIG. 15, may also include an input/output controller 1532 for receiving and processing input from a number of input devices, such as a keyboard, a mouse, a touchpad, a touch screen, an electronic stylus, or other type of input device. Similarly, an input/output controller 1532 may provide output to a display, such as a computer monitor, a flat-panel display, a digital projector, a printer, a plotter, or other type of output device. It will be appreciated that the computing device 1500 may not include all of the components shown in FIG. 15, may include other components that are not explicitly shown in FIG. 15, or may utilize an architecture completely different than that shown in FIG. 15.

As described herein, a computing device may be a physical computing device, such as the computing device 1500 of FIG. 15. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of efficiently extending a machine learning model to recognize new languages, comprising:
maintaining a first data flow pipeline of the machine learning model, wherein the first data flow pipeline comprises pre-trained parameters and is pre-trained to recognize existing languages based on input audio;
configuring a second data flow pipeline of the machine learning model, wherein the second data flow pipeline is configured to utilize the pre-trained parameters of the first data flow pipeline and leverage additional parameters, and wherein the additional parameters are trainable; and
fine-tuning the machine learning model by exclusively updating the additional parameters of the second data flow pipeline using data from the new languages, wherein the machine learning model is fine-tuned to recognize the new languages based on input audio while preserving performance in recognizing the existing languages.

2. The method of claim 1, wherein the first data flow pipeline comprises a first encoder, wherein the second data flow pipeline comprises a second encoder, and wherein the second encoder comprises trainable low-rank matrices to efficiently adapt model parameters.

3. The method of claim 2, wherein the method further comprises:
applying the second encoder to all pre-trained weight matrices in sub-layers of the first encoder, wherein the sub-layers comprise a multi-head attention (MHA) layer and a feed-forward (FF) layer.

4. The method of claim 2, wherein the second encoder comprises a low-rank adaptation (LoRA).

5. The method of claim 1, wherein the first data flow pipeline comprises a first decoder, wherein the second data flow pipeline comprises a second decoder, and wherein the method further comprises:
utilizing the second decoder alongside a multi-head additive attention mechanism; and
forming a Listen, Attend, and Spell (LAS) framework.

6. The method of claim 1, further comprising:
applying distinct final layer normalizations before passing encoder outputs from the first data flow pipeline and the second data flow pipeline to their respective decoders.

7. The method of claim 1, further comprising:
avoiding merging a low-rank adaptation (LoRA) of the second data flow pipeline with pre-trained weight matrices of the first data flow pipeline during a decoding stage.

8. The method of claim 1, further comprising:
determining a final recognition output between outputs from a first decoder of a first data flow pipeline and from a second decoder of the second data flow pipeline by applying a decoder selection mechanism.

9. The method of claim 8, further comprising:
comparing log-probability scores of identified language tags output from the first decoder and output from the second decoder; and
comparing average log-probability scores of full transcripts in response to determining that a difference between the log-probability scores of the identified language tags is less than a predetermined threshold.

10. A system for efficiently extending a machine learning model to recognize new languages, comprising:
at least one processor; and
at least one memory communicatively coupled to the at least one processor and comprising computer-readable instructions that upon execution by the at least one processor cause the at least one processor to perform operations comprising:
maintaining a first data flow pipeline of the machine learning model, wherein the first data flow pipeline comprises pre-trained parameters and is pre-trained to recognize existing languages based on input audio;
configuring a second data flow pipeline of the machine learning model, wherein the second data flow pipeline is configured to utilize the pre-trained parameters of the first data flow pipeline and leverage additional parameters, and wherein the additional parameters are trainable; and
fine-tuning the machine learning model by exclusively updating the additional parameters of the second data flow pipeline using data from the new languages, wherein the machine learning model is fine-tuned to recognize the new languages based on input audio while preserving performance in recognizing the existing languages.

11. The system of claim 10, wherein the first data flow pipeline comprises a first encoder, wherein the second data flow pipeline comprises a second encoder, and wherein the second encoder comprises trainable low-rank matrices to efficiently adapt model parameters.

12. The system of claim 11, the operations further comprising:
applying the second encoder to all pre-trained weight matrices in sub-layers of the first encoder, wherein the sub-layers comprise a multi-head attention (MHA) layer and a feed-forward (FF) layer.

13. The system of claim 11, wherein the second encoder comprises a low-rank adaptation (LoRA).

14. The system of claim 10, the operations further comprising:
applying distinct final layer normalizations before passing encoder outputs from the first data flow pipeline and the second data flow pipeline to their respective decoders.

15. The system of claim 10, the operations further comprising:
determining a final recognition output between outputs from a first decoder of a first data flow pipeline and from a second decoder of the second data flow pipeline by applying a decoder selection mechanism.

16. A non-transitory computer-readable storage medium, storing computer-readable instructions that upon execution by a processor cause the processor to implement operations comprising:
maintaining a first data flow pipeline of the machine learning model, wherein the first data flow pipeline comprises pre-trained parameters and is pre-trained to recognize existing languages based on input audio;
configuring a second data flow pipeline of the machine learning model, wherein the second data flow pipeline is configured to utilize the pre-trained parameters of the first data flow pipeline and leverage additional parameters, and wherein the additional parameters are trainable; and
fine-tuning the machine learning model by exclusively updating the additional parameters of the second data flow pipeline using data from the new languages, wherein the machine learning model is fine-tuned to recognize the new languages based on input audio while preserving performance in recognizing the existing languages.

17. The non-transitory computer-readable storage medium of claim 16, wherein the first data flow pipeline comprises a first encoder, wherein the second data flow pipeline comprises a second encoder, and wherein the second encoder comprises trainable low-rank matrices to efficiently adapt model parameters.

18. The non-transitory computer-readable storage medium of claim 17, the operations further comprising:
applying the second encoder to all pre-trained weight matrices in sub-layers of the first encoder, wherein the sub-layers comprise a multi-head attention (MHA) layer and a feed-forward (FF) layer.

19. The non-transitory computer-readable storage medium of claim 16, the operations further comprising
applying distinct final layer normalizations before passing encoder outputs from the first data flow pipeline and the second data flow pipeline to their respective decoders.

20. The non-transitory computer-readable storage medium of claim 16, the operations further comprising:
determining a final recognition output between outputs from a first decoder of a first data flow pipeline and from a second decoder of the second data flow pipeline by applying a decoder selection mechanism.
